(19) United States
(12) Patent Application Publication
(10) Pub. No.: US 2026/0273719 A1
(43) Pub. Date: Sep. 17, 2026

(54) ERGONOMIC HAMMER/AXE STRUCTURE

(71) Applicants: Jui-Yuan Shih, Changhua (TW); Yi-Ting Shih, Changhua (TW)

(72) Inventors: Jui-Yuan Shih, Changhua (TW); Yi-Ting Shih, Changhua (TW)

(21) Appl. No.: 19/556,751

(22) Filed: Mar. 4, 2026

(30) Foreign Application Priority Data
Mar. 14, 2025 (CN) 114109899

(51) Int. Cl. B25G 1/10; B25D 1/04; B25D 1/12; B25G 3/26; B26B 23/00

(52) U.S. Cl. CPC B25G 1/102; B25D 1/045; B25D 1/12; B25G 3/26; B26B 23/00

(57) ABSTRACT

An ergonomic hammer/axe structure includes a handle and a striking component. The handle includes a first body, second body, and third body sequentially connected from distal end to proximal end. A central axis of the first body is inclined upward relative to a central axis of the second body by a first inclination angle. A central axis of the third body is inclined downward relative to the central axis of the second body by a second inclination angle. The striking component is disposed perpendicularly on first body. When a user grips third body and swings handle downward to cause striking component to strike a nail, striking component impacts the nail squarely via angular correction provided by first and second inclination angles, maintaining neutral wrist alignment and preventing the user's palm and thenar web space from being overextended. The striking component defines a parabolic surface.

### FIELD OF THE INVENTION

The present invention relates to an ergonomic hammer/axe structure, and more particularly to an ergonomic hammer/axe structure that facilitates gripping and corrects a striking direction.

### BACKGROUND OF THE INVENTION

In recent years, advances in science and technology have enabled automation or electric machinery to replace many tasks that previously required manual labor and hand tools. However, in daily life, many tasks still need to be completed through manual operation. For example, in construction and electrical work sites, or in home DIY decoration and renovation, many parts need to be completed by striking with a hammer. Conventional hammer designs have not accurately considered human factors engineering, causing users to have to adapt to hammers, or frequently choosing inappropriate hammers, and making inappropriate movements based on experience, or working beyond limits due to insufficient knowledge of work safety, thereby causing unnecessary fatigue and work injuries. Especially, in the process of using a hammer to strike nails, general users often strike nails obliquely or cause bending deformation, and frequently strike their own hands inadvertently, causing serious injuries. As a result, there is a real need for improvement.

Referring to FIGS. 18 and 19, a conventional hammer 90 includes a handle portion 91 and a head portion 92 disposed perpendicularly thereto. When a user grips the handle portion 91 and strikes a nail with the head portion 92, the head portion 92 may fail to align squarely with the nail. This misalignment occurs because the head portion 92 is perpendicular to the handle portion 91 and the gripping location is offset from the striking point. Consequently, the nail may be obliquely driven, and the user's hand, being in close proximity to the striking face, is at risk of impact or injury. Accordingly, there is a need for a tool that corrects the striking direction and enhances ergonomic safety.

Compared with general DIY hand tool users, construction site workers possess different levels of common knowledge and professional experience. Professional users at construction sites not only exhibit greater muscle endurance, physical fitness, and tool-handling skills, but also have more insight regarding the balance between work and rest. General users are relatively lacking in these aspects. When striking nails on walls, tabletops, or floors, the required striking angles vary because the work positions differ. Therefore, it is necessary to design hammers with various handle and head angles to accommodate different users and operating situations. This provides ergonomic advantages during prolonged use and enables nails to be struck correctly, thereby minimizing lateral deflection and structural deformation of the nail. To enhance striking precision, the inventor has applied geometric principles to design an optimized striking face. This ensures that nails do not necessarily have to be struck at the exact center point of the hammer face; even if the impact is offset to the side, the nail can still be driven in the user's intended direction.

After long-term research, the inventor has explored problems in conventional hammer design, the anatomical structure of the human upper limb, and injuries such as myofascial inflammation caused by improper use of tools, and has finally proposed the present invention, which substantially addresses the difficulty general users previously encountered in precisely striking nails.

Hammer operation is primarily executed by the hand. Consequently, to optimize hammer design, it is essential to understand the musculature of the human hand as it relates to striking motions. By applying principles of biomechanics, physiological anatomy, and motion analysis to the swinging of a hammer, hammers can be designed that are more ergonomically suited to the human body. The following discussion details the physiological and anatomical structures of the hand relevant to these operations.

The upper limb is divided into the upper arm, the forearm, and the hand. The upper arm is supported by the humerus, while the forearm comprises the radius and the ulna. The forearm connects to the palm at the wrist joint and to the humerus of the upper arm at the elbow joint.

The upper arm muscles include the biceps brachii, brachialis, brachioradialis, triceps brachii, anconeus, pronator muscles, supinator muscles, and the like. When the biceps brachii, brachialis, and brachioradialis contract, a forearm flexion motion is produced. The pronator muscles and supinator muscles produce forearm pronation and supination motions, respectively. However, the forearm flexion motion is primarily driven by the biceps brachii, while the triceps brachii is the primary muscle producing forearm extension.

The forearm muscles include the flexor carpi muscles, extensor carpi muscles, palmaris longus, flexor digitorum muscles, extensor digitorum muscles, adductor pollicis longus, abductor pollicis longus, flexor pollicis longus, and the like.

The wrist is a quite complex joint, connecting the palm and forearm. The carpal tunnel is located in a cavity of the wrist, connected with many small bones and ligaments. Several important nerves, blood vessels, and tendons pass through the carpal tunnel, enabling the palm to undergo various motions. According to research in human anatomy, it has been found that for an average person, the hand can achieve radial deviation of 15 to 20 degrees, ulnar deviation of 35 to 37 degrees, palmar flexion of 85 to 90 degrees, and dorsiflexion of 75 to 80 degrees. Since the carpal tunnel has a large number of nerves and blood vessels passing through it, excessive radial or ulnar deviation, or improper force application during such deviations, is likely to cause the nerves and blood vessels to be compressed and damaged. This condition is referred to as carpal tunnel syndrome.

The wrist motions of radial deviation, ulnar deviation, palmar flexion, and dorsiflexion are primarily controlled by two muscle groups, which can be divided into the extensor carpi muscle group and the flexor carpi muscle group. The extensor carpi muscle group consists of two extensor carpi muscles: the extensor carpi radialis and the extensor carpi ulnaris, which are responsible for wrist extension motion. Both muscles are attached at one end to the humerus of the upper arm, and the other end is respectively attached to the bones of the hand.

The muscle group located on the palmar side of the forearm is primarily responsible for wrist flexion, finger flexion, and pronation (palm turning downward). The forearm muscles are important muscle groups connecting the elbow and wrist, responsible for fine movements of the wrist and fingers as well as the rotational function of the forearm. The anterior forearm (flexor muscle group) is located on the palmar side of the forearm and is primarily responsible for wrist flexion, finger flexion, and pronation (palm turning downward), and is further divided into deep muscle groups and superficial muscle groups.

The superficial muscle group includes the following muscles. (1) Pronator teres—Origin: humeral head, medial epicondyle of the humerus (arises with the common flexor tendon from the humerus), ulnar head, medial margin of the coronoid process of the ulna (may be absent in some individuals). Insertion: middle portion of the lateral surface of the radius (forming the pronator teres tuberosity). Function: forearm pronation (palm turning posteriorly or toward the ground), assists in elbow flexion. (2) Flexor carpi radialis—Origin: medial epicondyle of the humerus. Insertion: base of the second metacarpal. Function: wrist flexion (bending the palm toward the forearm), radial deviation (wrist abduction, tilting the hand toward the thumb side), assists in forearm pronation. (3) Palmaris longus (absent in some individuals)—Origin: medial epicondyle of the humerus. Insertion: palmar aponeurosis. Function: wrist flexion, tensing the palmar aponeurosis. (4) Flexor carpi ulnaris—Origin: medial epicondyle of the humerus, ulna. Insertion: pisiform bone, base of the fifth metacarpal. Function: wrist joint flexion (palmar flexion), works synergistically with the flexor carpi radialis to bend the wrist, ulnar deviation (bending toward the little finger side, adduction), pulls the hand toward the ulnar side (little finger side) as in hammering or throwing motions, stabilizes the wrist joint, provides stability during first clenching or gripping. The flexor carpi ulnaris is one of the strongest flexors of the wrist and plays a critical role in ulnar deviation motion. Wrist flexion and adduction motions when using a hammer for striking or playing tennis rely on this muscle.

The deep muscle group includes the following muscles. (1) Flexor digitorum superficialis—Origin: medial epicondyle of the humerus, coronoid process of the ulna, anterior border of the radius. Insertion: middle phalanges of the second through fifth digits. Function: flexes the proximal interphalangeal joints (PIP), metacarpophalangeal joints (MCP), and wrist joint. (2) Flexor digitorum profundus—Origin: proximal anterior surface of the ulna and interosseous membrane. Insertion: distal phalanges of the second through fifth digits. Function: flexes the distal interphalangeal joints (DIP), assists in wrist flexion. (3) Flexor pollicis longus—Origin: anterior surface of the radius and interosseous membrane. Insertion: distal phalanx of the thumb. Function: flexes the interphalangeal joint (IP) of the thumb. (4) Pronator quadratus—Origin: distal anterior surface of the ulna (approximately the lower one-quarter anterior surface of the ulna). Insertion: distal anterior surface of the radius (approximately the lower one-quarter anterior surface of the radius). Function: forearm pronation, stabilizes the distal radioulnar joint (maintains wrist joint stability).

The superficial muscle group includes the following muscles. Extensor carpi radialis longus—Origin: lateral epicondyle of the humerus. Insertion: base of the second metacarpal. Function: wrist extension, radial deviation of the hand. Extensor carpi radialis brevis—Origin: lateral epicondyle of the humerus. Insertion: base of the third metacarpal. Function: wrist extension. Extensor digitorum—Origin: lateral epicondyle of the humerus. Insertion: distal and middle phalanges of the second through fifth digits. Function: extends the fingers (extends the metacarpophalangeal and interphalangeal joints). Extensor digiti minimi—Origin: lateral epicondyle of the humerus. Insertion: dorsal digital expansion of the little finger. Function: extends the little finger. Extensor carpi ulnaris—Origin: lateral epicondyle of the humerus, posterior border of the ulna. Insertion: base of the fifth metacarpal. Function: extends the wrist joint (wrist dorsiflexion), participates in ulnar deviation of the wrist joint (hand tilting toward the little finger side).

The deep muscle group includes the following muscles. (1) Supinator—Origin: lateral epicondyle of the humerus, proximal ulna. Insertion: proximal anterior surface of the radius. Function: forearm supination. (2) Abductor pollicis longus—Origin: posterior surfaces of the ulna and radius. Insertion: base of the first metacarpal. Function: abducts the thumb (away from the palm). (3) Extensor pollicis brevis—Origin: posterior surface of the radius. Insertion: proximal phalanx of the thumb. Function: extends the metacarpophalangeal joint (MCP) of the thumb. (4) Extensor pollicis longus—Origin: posterior surface of the ulna. Insertion: distal phalanx of the thumb. Function: extends the interphalangeal joint (IP) of the thumb. (5) Extensor indicis—Origin: posterior surface of the ulna. Insertion: dorsal digital expansion of the index finger. Function: independently extends the index finger.

Summary of forearm functions is as follows: (1) flexion: bending of the wrist and fingers (such as making a fist); (2) extension: straightening of the wrist and fingers (such as opening the palm); (3) pronation: internal rotation of the forearm (such as turning a screw); (4) supination: external rotation of the forearm (such as turning the palm upward); and (5) radial deviation and ulnar deviation: tilting of the wrist toward the thumb or little finger side.

Hand motion in the horizontal plane toward the thumb side, that is, motion in the radial direction, is referred to as radial deviation. Hand motion in the horizontal plane toward the little finger side, that is, motion in the ulnar direction, is referred to as ulnar deviation.

When using a hammer to strike nails, the primary biomechanical motions of the limb consist of two types. The first is reciprocating motion, characterized by the limb following a curvilinear path that performs back-and-forth translational movement. The second is oscillatory motion, characterized by the limb performing back-and-forth rotational movement.

In terms of biomechanics, these two motions consist of shoulder flexion and elbow flexion. The reciprocal motion is governed by the shoulder muscle group, which controls shoulder flexion and is primarily driven by the latissimus dorsi and associated muscle groups. Additionally, the swinging motion of elbow flexion is controlled by the upper arm muscle group, primarily through the contraction of the triceps brachii and biceps brachii. Regarding the wrist joint, rotation is primarily controlled by muscle groups including the extensor carpi radialis, flexor carpi radialis, extensor carpi ulnaris, and flexor carpi ulnaris. Each of these actions is coordinated by two or more synergistic muscle groups. The hammer strikes downward from a high position (downswing), and after striking is completed, the hammer head is raised upward (upswing) from the highest point. The downward strike occupies one-third of the entire cycle, being an acceleration phase that provides the force needed for striking. The upward raising is a deceleration process, returning the limb to the required height. Through such repetition, complex hammer striking work is completed. In the entire striking operation, the muscle groups activate and proceed as shown below.

Analysis of hammer striking motion is shown in the following table:

| phase | body part | motion | muscle groups |
|---|---|---|---|
| downswing | arm | shoulder flexion → extension | shoulder muscle group |
| | forearm | elbow flexion → extension | upper arm muscle group |
| | wrist joint | radial deviation → ulnar | forearm muscle group |
| | | deviation | |
| upswing | arm | extension → shoulder flexion | shoulder muscle group |
| | forearm | extension → elbow flexion | upper arm muscle group |
| | wrist joint | ulnar deviation → radial | forearm muscle group |
| | | deviation | |

Musculoskeletal occupational injuries resulting from the use of hand-held hammers are generally categorized as follows:

Acute Injuries: These include contusions, lacerations, crush injuries, and sprains. Such injuries primarily result from improper work methods, lack of experience, ergonomic deficiencies in tool design, or hazardous work environments, causing immediate and localized trauma. Because the symptoms are overt, medical treatment is typically sought promptly, which reduces the likelihood of long-term sequelae. During the nail-striking process, the most frequent occurrence is an accidental impact to the hand stabilizing the nail—specifically during the initial stage where the nail is being positioned and set into the workpiece prior to the full driving stroke.

Chronic or Cumulative Injuries: These include tendinopathy (such as tendonitis), carpal tunnel syndrome, and related disorders. Affected areas typically exhibit symptoms such as numbness, blanching (indicative of impaired blood circulation), localized pain, loss of motor control, or diminished sensitivity to thermal stimuli. These conditions generally result from cumulative trauma caused by prolonged work in ergonomically improper postures or the use of poorly designed tools. Since initial symptoms are often subtle, they are frequently overlooked; however, long-term accumulation can lead to irreversible pathology or chronic sequelae that are difficult to treat.

Cumulative injuries may be categorized by their anatomical location: injuries to the hand and wrist include tendonitis, carpal tunnel syndrome, and Raynaud's phenomenon (white finger syndrome). In the forearm and elbow, common afflictions include lateral epicondylitis (tennis elbow), radial tunnel syndrome, and extensor tenosynovitis. Furthermore, shoulder-related cumulative injuries frequently manifest as supraspinatus tendonitis.

Cumulative trauma related to hammer use: Because hammers are designed to generate high impact force, the center of gravity is typically biased toward the distal end of the tool. During the preparatory phase of a strike, the forearm undergoes pronation while the wrist joint performs radial deviation and dorsiflexion; this combination of movements can lead to lateral epicondylitis (tennis elbow). At the moment of impact, the forearm pronates forcefully as the wrist joint transitions into a strong ulnar deviation, frequently resulting in tendonitis.

Research regarding the geometry and dimensions of the hand-contact interface has identified that the center of the palm is the most sensitive region of the hand, exhibiting the lowest tolerance for continuous pressure. This is followed by the thenar eminence (the base of the thumb near the palm center) and the digital regions (the fingers). In the research of the present invention, it has been found that an ergonomically designed hammer—incorporating an optimized handle-to-head angular relationship—can substantially reduce vibrations of the handle within the user's palm during the swing and strike phases. This design further reduces the transmission of impact vibrations to the palm.

Research on hammer-striking patterns reveals that professional construction workers primarily utilize the triceps brachii of the upper arm to drive the forearm. This biomechanical approach achieves higher operational efficiency and minimizes fatigue. By contrast, it has been observed that general users tend to place the greatest muscular load on the flexor carpi radialis and flexor carpi ulnaris during the swing. Consequently, the anatomical regions of localized fatigue and soreness experienced by general users differ significantly from those of construction workers.

Biomechanical Force Distribution and Motion Analysis of Upper Arm and Forearm: During the nail-striking process, the muscles utilized to elevate the hammer include the extensor carpi radialis of the forearm and the biceps brachii of the upper arm, which collectively govern wrist and forearm trajectory. During the downward strike, a significant disparity in muscular engagement is observed between user groups. General users exhibit a primary force concentration in the extensor carpi radialis and extensor carpi ulnaris. By contrast, professional users distribute the greatest proportion of force to the triceps brachii. This difference lies not only in the timing of peak force but also in its anatomical distribution; professional users concentrate force in the upper arm, whereas general users rely on the forearm. Given the greater physiological capacity of the upper arm musculature compared to the forearm, this distribution directly dictates strike magnitude and endurance, ultimately influencing overall operational efficiency and the rate of fatigue.

Research indicates that in the process of professional users striking nails, the muscle with the greatest force percentage is the triceps brachii (approximately 45%), meaning the maximum force proportion is used in the downward swinging motion. For general users, the flexor carpi radialis has the greatest force percentage (approximately 47%), meaning the maximum force is used when raising the hammer, making general users less efficient and more prone to fatigue. Professional users use the large and powerful triceps brachii to drive the forearm downward. During the downswing of a hammer, general users primarily utilize the smaller flexor carpi radialis to rotate the wrist. In addition to the lower muscular force generated by this smaller muscle group, the moment arm is also shorter. This configuration naturally yields lower force output compared to professional users, resulting in reduced operational efficiency. This demonstrates that the disparity in efficiency between general and professional users is fundamentally a result of differing biomechanical execution patterns.

Postural Disparities in General Subjects: General users who rarely use hammers to strike nails exhibit smaller forearm swing arcs than professional users. Their hammer swing is mainly driven by swinging the palm, using the wrist joint as the principal axis. Because this motion uses smaller muscle groups—specifically the flexor carpi radialis and extensor carpi radialis—it results in lower force output and accelerated fatigue, requiring a higher frequency of strokes to drive a nail into wood. Professional users employ a more expansive range of motion when swinging a hammer. The striking sequence is initiated by the upper arm, utilizing the shoulder and elbow joints as primary axes. By articulating the upper arm and forearm through larger angular displacements, the triceps brachii becomes the primary load-bearing muscle. Anatomically, this movement also entails using substantial muscle groups—including the deltoid and latissimus dorsi—to drive the forearm through a wider arc. This biomechanical approach not only generates greater momentum but also significantly reduces localized fatigue, thereby increasing the overall operational efficiency and increasing the number of nails that can be driven. However, since the motions controlled by the latissimus dorsi are complex, they are related not only to up-and-down swinging of the upper arm in nail striking work, but also control upper arm extension, adduction, internal rotation, and even pulling the scapula downward and backward, all completed by contraction of this muscle.

The upper-limb muscles employed during hammer use are mainly flexor carpi radialis, extensor carpi radialis, biceps brachii, and triceps brachii. For the average users, the workload among these muscles is heavily unbalanced, with the extensor carpi radialis bearing the brunt of the force. This mechanical overreliance is the root cause of the forearm strain and soreness common among the average users. Consequently, the present disclosure investigates whether adjusting the handle curvature can redistribute this load. The goal of this design is to alleviate the burden on the extensor carpi radialis, thereby reducing fatigue of the forearm while enhancing both comfort and striking efficiency—effectively bridging the gap between novice form and professional-grade technique.

The research of the present invention entailed studying the bending angle of the hammer handle and the bending angle of the hammer head. Evaluation criteria focus mainly on the degree of wrist radial deviation and ulnar deviation, subjective preference after work, work efficiency during work execution, and the precision of nail positioning. This is because using a hammer is usually accompanied by strong impacts in radial and ulnar deviation directions, creating great pressure on the palm. Long-term workers also frequently suffer from wrist-related cumulative musculoskeletal injuries. The precision of nail positioning (positioning a nail, using a magnet in the nail positioning groove on the hammer head to attract the nail, without holding the nail with the hand, directly swinging the hammer with one hand to fix the nail to the board) enables precise nail positioning. Consequently, users no longer need to manually stabilize the nail, thereby eliminating the risk of accidental impact to the hand.

Impact of Handle Geometry and Center of Gravity: Research was conducted on how handle angle and center of gravity positioning influence nail-striking operations, specifically regarding grip strength attenuation and radial-ulnar deviation of the wrist. The study found that conventional straight-handled hammers result in minimal radial deviation but excessive ulnar deviation.

General users frequently struggle with striking precision; if the impact occurs off-center on the hammer head, misses the center of the nail head, or if the strike angle is skewed, the nail will bend or deflect. This leads to workpiece damage and user frustration. Therefore, it is critical to integrate an ergonomic handle angle with a corrected head orientation to ensure the striking face meets the nail perpendicularly. Furthermore, by applying geometric principles, a striking face having a parabolic profile can be utilized. This design provides a greater “margin of error” for the grip angle, strike perpendicularity, and user skill level, effectively preventing deflection while enhancing operational efficiency and user confidence.

Summary of Ergonomic Requirements: To meet ergonomic standards, a hammer design must achieve the following during use: 1. Maintain a neutral wrist alignment to prevent ulnar deviation; 2. Prevent soft tissue compression; 3. Attenuate impact vibrations transmitted to the hand; 4. Ensure nail-striking precision.

Improper hand positioning can lead to cumulative trauma disorders, such as carpal tunnel syndrome, tenosynovitis, and trigger finger. During the striking process, the user's hand naturally tends toward ulnar deviation while absorbing significant impact forces, leading to cumulative fatigue and occupational injury. Consequently, handle design must prioritize the elimination of ulnar deviation.

Manual tool operation requires substantial grip force while simultaneously absorbing reactive shocks. The center of the palm contains critical blood vessels and nerves and is exceptionally sensitive to pressure. Intense impact and compressive forces can obstruct blood flow through the ulnar artery, causing localized ischemia. This often leads to numbness and paresthesia (tingling) in the fingers. To address this, hammer design should minimize pressure on the center of the palm, instead redistributing forces toward the finger joints or the thenar eminence (the base of the thumb) to allow for effective force application and reduced pressure on the center of the palm.

Rebound force effects mostly appear in vibration induced in the upper arm and forearm or palm from using hand tools. In the hammer striking process, strong impact force causes numbness in the palm and finger areas. Short-term striking does not cause user discomfort. But with long-term use, hand vibration sensitivity decreases, and this leads to desensitized operation, where the user—unaware of the excessive force or vibration being absorbed—continues to strike in a manner that triggers numbness and paresthesia (tingling) in the fingers.

Referring to FIG. 18, when the user grips and strikes downward with the handle portion 91, it is relatively close to the surface, which is a relatively unnatural phenomenon, and the hand may be injured from striking the surface. The human hand instinctively automatically moves away to avoid striking the surface to prevent injury—this is a self-protective mechanism. Referring to FIG. 19, the user therefore rotates the head portion 92 inward to correct its downward striking direction, but it still has the problem of being unable to squarely align with the nail.

When the conventional hammer 90 strikes downward, excessive rotation amplitude of the handle portion 91 also prevents the user's hand from fitting with the handle portion 91, causing the palm and thenar web space to be overextended, or excessive wrist torsion amplitude, or the handle portion 91 tilting without being wrapped by the user's palm, causing striking vibration to injure vulnerable areas of the hand. After prolonged striking, the hand becomes quite sore and there is risk of dropping the conventional hammer 90. Improper tool design causes physical injuries over the long term, such as muscle injury diseases like carpal tunnel syndrome and tenosynovitis. Many jobs require frequent use of hand tools, making the incidence of such cumulative traumatic pathology very high—it is an occupational injury that reduces work willingness over time. Improving tools is equivalent to improving the work environment.

Following extensive research, the inventor has analyzed the systemic deficiencies in conventional hammer design, the dynamics of off-axis force application on nails, and the biomechanical constraints of the human upper limb. This study specifically addressed musculoskeletal pathologies, such as myofascial inflammation, resulting from the improper use of tools affecting the upper arm, forearm, wrist, and palm. These efforts have culminated in the present invention—the Ergonomic Hammer/Axe Structure—which substantially resolves the strike-precision issues common among general users. Leveraging years of practical experience and iterative prototyping, the inventor utilized multi-directional testing and refinement to finalize the current design.

### SUMMARY OF THE INVENTION

Technical issue to address is that in view of the aforementioned drawbacks of the prior art, it is an objective of the disclosure to provide an ergonomic hammer/axe structure that facilitates gripping and corrects a striking direction.

The experimental methodology for the present disclosure involved the prototyping of dozens of hammer configurations featuring varied handle and head angles. These prototypes were subjected to practical striking tests by multiple operators. Data was captured using high-speed videography at frame rates of 120 fps, 240 fps, and 7680 fps to allow for precise motion analysis. The research evaluated the verticality of nail placement during one-handed positioning—a process facilitated by a magnetic groove in the hammer head that obviates the need for manual stabilization. The perpendicularity of the strike face relative to the workpiece at the moment of impact for each angular variation was recorded. Kinematic data was extracted from the video to analyze the angular displacements of the palm, wrist, forearm, elbow, upper arm, and shoulder joint. Furthermore, after subjects performed dozens of consecutive strikes, localized fatigue and muscle group activation were recorded. This subjective feedback, combined with objective biomechanical data, allowed for the deduction of optimal ergonomic principles. The resulting design was then validated through large-scale testing involving a diverse demographic, including professional formwork masters, electricians, and general male and female users. This iterative process, encompassing tens of thousands of individual strikes, confirmed that while ergonomic preferences can be subjective, there are distinct behavioral habits in tool usage. By optimizing for these habitual motions, the present disclosure provides a design that is fundamentally aligned with human physiology. The present invention is the result of research totaling tens of thousands of striking tests.

The present disclosure demonstrates that the handle angle of a hand tool significantly influences the radial and ulnar deviation of the wrist. By configuring the handle geometry to maintain a neutral wrist alignment during operation, the design facilitates optimal force application while mitigating cumulative trauma disorders of the hand. Furthermore, the head angle is specifically configured to optimize the vertical alignment between the handle and the striking face. An integrated shock-attenuating spring within the hammer head provides a dampening effect to protect the palmar region. Additionally, a striking face having a parabolic profile is utilized to enhance nail-striking precision.

Solution to Technical Problems: the present disclosure provides an ergonomic hammer/axe structure comprising a handle and a striking component. The handle comprises a first body, a second body, and a third body. The first body, the second body, and the third body are sequentially connected from a distal end to a proximal end. A central axis of the first body is inclined upward relative to a central axis of the second body by a first inclination angle. A central axis of the third body is inclined downward relative to the central axis of the second body by a second inclination angle. The striking component is disposed perpendicularly to the first body. When a user grips the third body and swings the handle downward to cause the striking component to strike a nail, the striking component impacts the nail squarely via angular correction provided by the first body, the second body, and the third body, maintaining a neutral wrist alignment and preventing the user's palm and thenar web space from being overextended by the third body due to handle inclination, enabling the handle to provide ergonomic advantages during prolonged use. The striking component comprises a hammer head or an axe blade and defines a striking face having a parabolic profile.

Optionally, the striking component comprises a striking component body, a shock-attenuating spring, and a nut. The first body comprises an assembly hole penetrating therethrough. One end of the striking component body comprises a striking head protruding therefrom. Another end of the striking component body extends through the assembly hole and is secured by the nut. The shock-attenuating spring is interposed between the striking head and the first body to elastically absorb vibration, thereby mounting the striking component to the first body.

Optionally, the striking component is integrally formed with the first body.

A primary objective of the present disclosure is to correct the striking direction to substantially prevent axial deviation of a nail body, to prevent excessive inclination angle of the third body from causing the user's palm and thenar web space to be overextended or the wrist to be excessively bent, and thereby to enhance gripping comfort and prevent work injuries. The central axes of the first body and the second body, as well as the central axes of the second body and the third body, are mutually inclined with the first inclination angle and second inclination angle present, enabling correction of the angle between the third body and the striking component through the first inclination angle and the second inclination angle.

Designing a striking face having a parabolic profile enhances nail striking precision.

Other objectives, advantages, and novel features of the present disclosure will become more apparent from the following detailed description and accompanying drawings.

### BRIEF DESCRIPTION OF THE SEVERAL VIEWS OF THE DRAWINGS

FIG. 1 is a perspective view of the hammer of the present disclosure.

FIG. 2 is an exploded view of the hammer of the present disclosure.

FIG. 3 is a front view of the hammer of the present disclosure.

FIG. 4 is a schematic view of the hammer in use according to the present disclosure.

FIG. 5 is a schematic view of a user's hand gripping a third body of a handle of the hammer of the present disclosure.

FIG. 6 is a schematic view of a striking face of the hammer of the present disclosure.

FIG. 7 is a schematic view of a spring of the hammer of the present disclosure.

FIG. 8 is a schematic view of a striking face of the axe of the present disclosure.

FIG. 9 is a schematic view of a spring of the axe of the present disclosure.

FIG. 10 is a front view of the axe of the present disclosure.

FIG. 11 is a front view of another aspect of the axe of the present disclosure.

FIG. 12 is a front view according to the first embodiment of the present disclosure.

FIG. 13 is a front view according to the second embodiment of the present disclosure.

FIG. 14 is a front view according to the third embodiment of the present disclosure.

FIG. 15 is a front view of another aspect of the hammer of the present disclosure.

FIG. 16 is a schematic view of another aspect of the hammer in use according to the present disclosure.

FIG. 17 is a front view of yet another aspect of the axe of the present disclosure.

FIG. 18 (PRIOR ART) is a schematic view of a conventional hammer in use.

FIG. 19 (PRIOR ART) is another schematic view of the conventional hammer in use.

### DETAILED DESCRIPTION OF THE INVENTION

Objectives, features, and advantages of the disclosure are herein illustrated with specific embodiments, depicted with drawings, and described below.

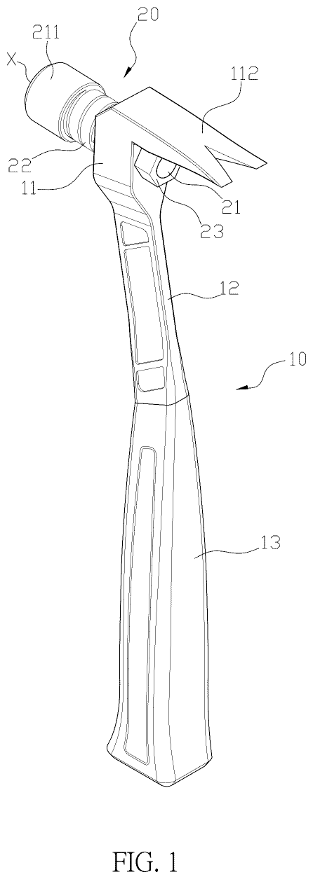

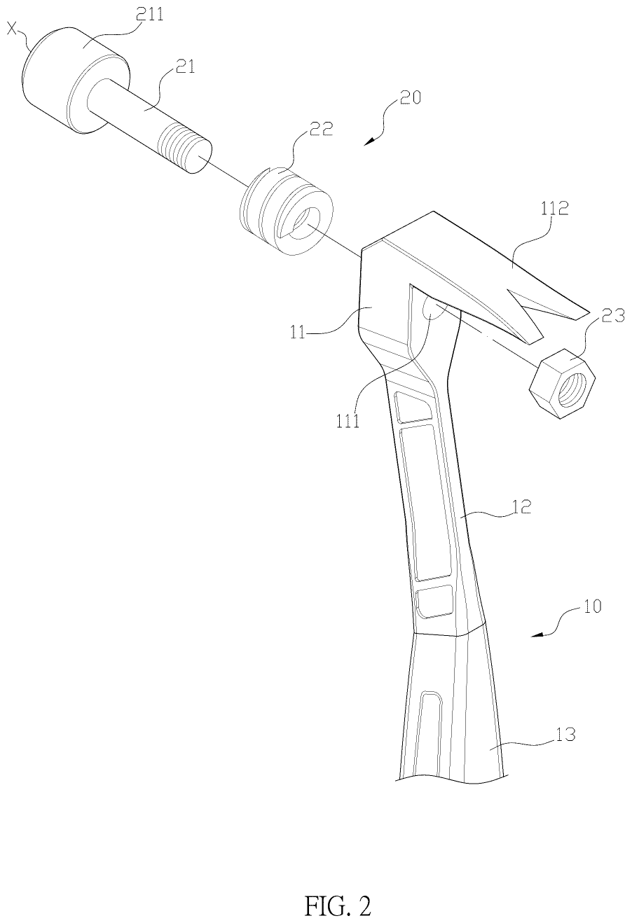

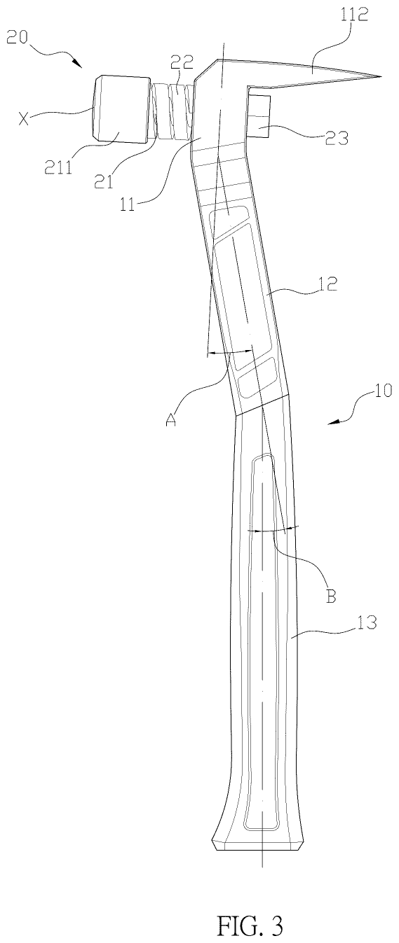

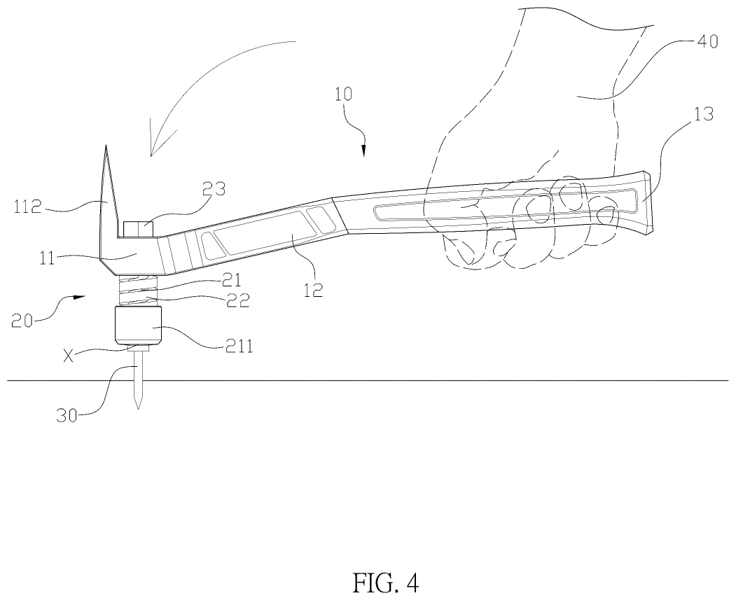

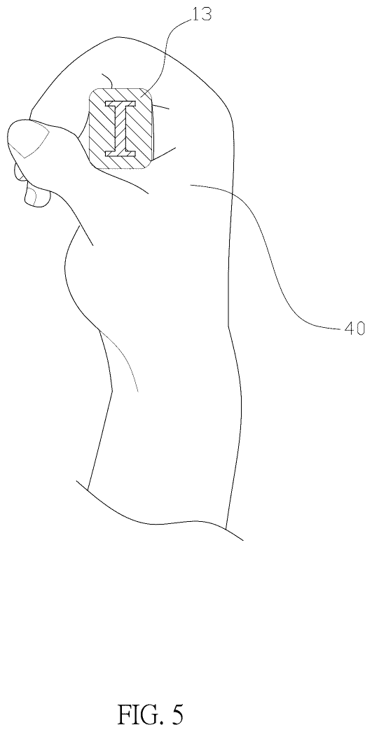

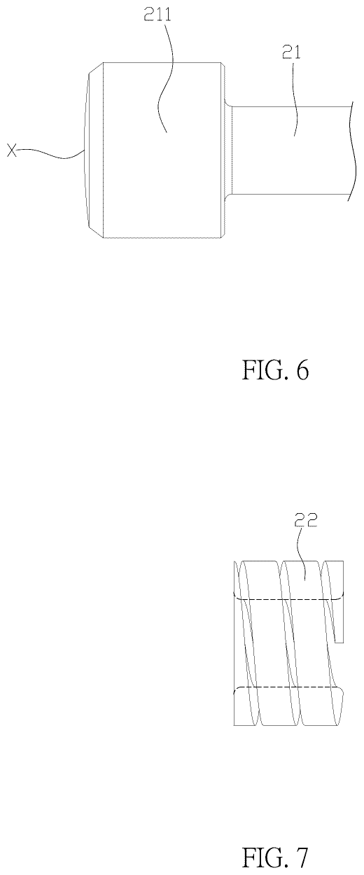

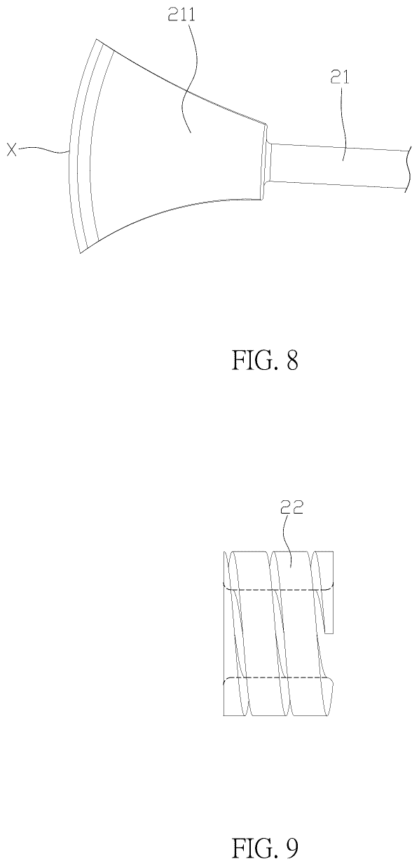

Referring to FIG. 1 through FIG. 3, the present disclosure provides an ergonomic hammer/axe structure comprising a handle 10 and a striking component 20. The handle 10 comprises a first body 11, a second body 12, and a third body 13. The first body 11, the second body 12, and the third body 13 are sequentially connected from a distal end to a proximal end. The central axis of the first body 11 is inclined upward relative to the central axis of the second body 12 by a first inclination angle A. The central axis of the third body 13 is inclined downward relative to the central axis of the second body 12 by a second inclination angle B. The striking component 20 is disposed perpendicularly to the first body 11. Referring to FIGS. 4 and 5, when a user grips the third body 13 and swings the handle 10 downward to cause the striking component 20 to strike a nail 30, the striking component 20 impacts the nail 30 squarely via angular correction provided by the first body 11, the second body 12, and the third body 13, maintaining a neutral wrist alignment and preventing the user's palm and thenar web space from being overextended by the third body 13 due to inclination of the handle 10, enabling the handle 10 to provide ergonomic advantages during prolonged use. Referring to FIGS. 6 and 8, the striking component 20 comprises a hammer head or an axe blade.

Referring to FIGS. 6 and 8, the present disclosure provides an ergonomic hammer/axe structure, wherein the striking component 20 defines a striking face X having a parabolic profile.

The geometric principle behind designing the striking face as a parabolic surface is as follows: The focal point of the parabolic surface is located at the center of the main force application portion. The distance from this focal point to the striking face is defined as the focal length of this parabolic surface. The striking face is designed as this parabolic surface. When force emanates from this focal point toward a nail head contacting the parabolic surface, the resulting force vector is parallel to the main axis of the parabolic surface. Consequently, when the nail comes into contact with the striking face having a parabolic profile, the nail is aligned squarely with the nail regardless of whether the striking point is centered or offset to the side. Such parabolic surface can be precisely manufactured using CNC lathe machining.

In a shock-attenuating hammer, the striking face is designed as a parabolic surface. The focal point of this parabolic surface may be located at the center of the junction between the hammer head body and the hammer's striking head. The center of the main force application portion is located at the central area of the lower end face of the shock-attenuating spring. The distance from this focal point to the striking face is designed as the focal length of this parabolic surface. This location is designed as the center of the main force application portion, and the direction of a nail striking force is the same as the direction of swinging the hammer. Even if the orientation of the handle is tilted, the nail will not deviate from its intended path provided that the swing direction of the hammer—which defines the direction of the striking force—remains correct.

The shock-attenuating hammer defines a striking face having a parabolic profile. The focal point of this parabolic surface may also be located at the center of the junction between the hammer head body and the first body. The center of the main force application portion is located at the central area of the upper end face of the shock-attenuating spring. The distance from this focal point to the striking face is designed as the focal length of this parabolic surface. This location is designed as the center of the main force application portion, and the direction of nail striking force is perpendicular to the lower platform of the first body, that is, the angle at which the user grips the handle determines the direction of nail striking force.

In a hammer without a shock-attenuating spring, the striking face is designed as a parabolic surface. The focal point of this parabolic surface may be located at the center of the junction between the hammer body and the hammer head body. The distance from this focal point to the striking face is designed as the focal length of this parabolic surface.

In a hammer without a shock-attenuating spring, the striking face is designed as a parabolic surface. The focal point of this parabolic surface may also be located at the center of the junction between the striking head of the hammer head and the hammer head body. The distance from this focal point to the striking face is designed as the focal length of this parabolic surface.

In a shock-attenuating axe, the edge portion (striking face) of the axe blade is designed as a parabolic surface. The focal point of this parabolic surface may be located at the center of the junction between the striking component body of the axe blade and the uppermost platform of the axe face, that is, the central location below the shock-attenuating spring. The distance from this focal point to the edge portion of the axe blade is designed as the focal length of this parabolic surface.

In a shock-attenuating axe, the edge portion of the axe blade is designed as a parabolic surface. The focal point of this parabolic surface may also be located at the center of the junction between the striking component body of the axe blade and the first body, that is, the central location above the shock-attenuating spring. The distance from this focal point to the edge portion of the axe blade is designed as the focal length of this parabolic surface.

In an axe tool without a shock-attenuating spring, the edge portion of the axe blade is designed as a parabolic surface. The focal point of this parabolic surface may be located at the center of the junction between the axe tool body and the axe blade body. The distance from this focal point to the edge portion of the axe blade is designed as the focal length of this parabolic surface.

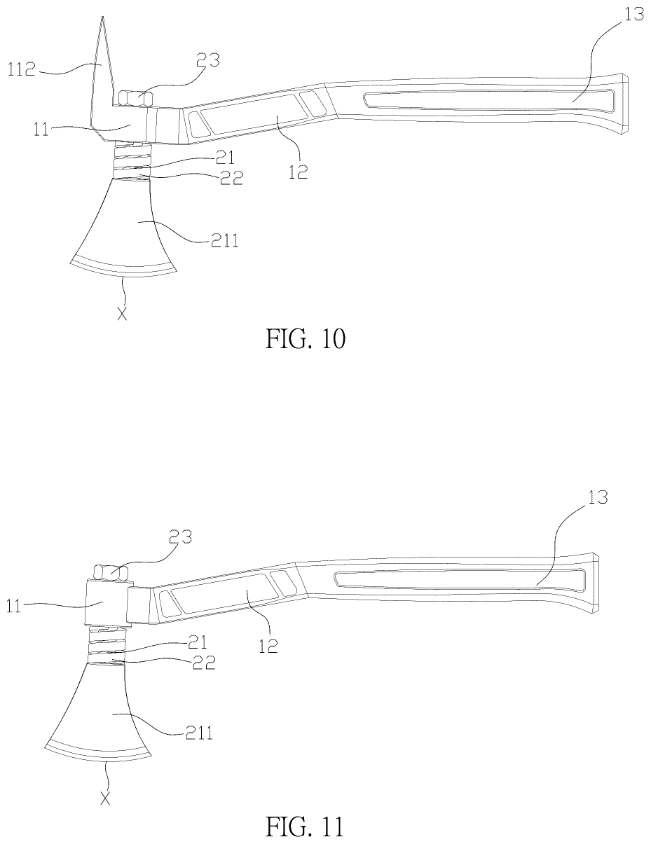

Referring to FIGS. 1-3, 10, and 11, the present disclosure provides an ergonomic hammer/axe structure. FIG. 10 illustrates a shock-attenuating dual-purpose axe comprising a nail pulling portion 112 configured to perform a digging function and characterized by the absence of a V-notch groove. FIG. 11 shows a shock-attenuating axe, wherein the striking component 20 comprises a striking component body 21, a shock-attenuating spring 22, and a nut 23. The first body 11 comprises an assembly hole 111 penetrating therethrough. One end of the striking component body 21 comprises a striking head 211 protruding therefrom. Another end of the striking component body 21 extends through the assembly hole 111 and is secured by the nut 23. The shock-attenuating spring 22 is interposed between the striking head 211 and the first body 11 to elastically absorb vibration, thereby mounting the striking component 20 to the first body 11. The striking component 20 provides enhanced shock absorption to mitigate occupational injuries.

Referring to FIGS. 6 and 7, in one exemplary embodiment of the ergonomic hammer/axe structure of the present disclosure, the striking component 20 is configured as a hammer head. A rounded fillet (also referred to herein as an R-angle) is disposed at an interface between the striking head 211 and the striking component body 21 for structural reinforcement. An inner structure of the shock-attenuating spring 22 also comprises a corresponding rounded fillet (R-angle) configured to mate with the rounded fillet disposed at the interface between the striking head 211 and the striking component body 21.

Referring to FIGS. 8 and 9, in another exemplary embodiment of the ergonomic hammer/axe structure of the present disclosure, the striking component 20 is configured as an axe blade. A rounded fillet (also referred to herein as an R-angle) is disposed at an interface between the striking head 211 and the striking component body 21 for structural reinforcement. An inner structure of the shock-attenuating spring 22 also comprises a corresponding rounded fillet (R-angle) configured to mate with the rounded fillet disposed at the interface between the striking head 211 and the striking component body 21.

Referring to FIG. 4 and FIG. 5, a hand 40 of a user is shown gripping a third body 13 of the handle 10. Through the angular correction between the first body 11, the second body 12, and the third body 13, the hand 40 is positioned further away from the striking face to prevent injury during an impact event. Furthermore, the hand 40 can securely grip the third body 13 without the grip being forced open by instability of the handle portion. This ensures the striking component 20 remains aligned with the nail 30 during impact, thereby improving construction quality.

The present disclosure provides an ergonomic hammer/axe structure, wherein the first body 11 further comprises a nail pulling portion 112 extending from a top portion thereof and configured to remove the nail 30 via leverage.

The present disclosure provides an ergonomic hammer/axe structure, wherein the first inclination angle A ranges from 3 degrees to 10 degrees, and the second inclination angle B ranges from 8 degrees to 17 degrees.

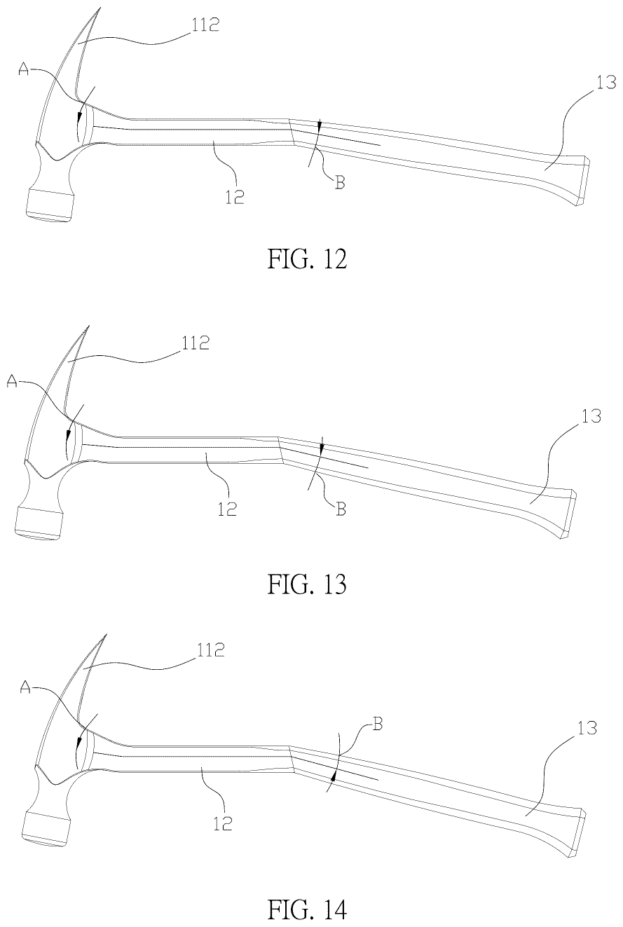

Referring to FIG. 12, in one embodiment, the first inclination angle A is 5 degrees, and the second inclination angle B is 10 degrees, providing optimal grip comfort and impact alignment correction. The 10-degree correction of the second inclination angle B provides ergonomic advantages during prolonged use. This configuration is derived from observing user habits during impact events while the user is holding the handle 10 by the hand 40. It allows the hand 40 to maintain a safe distance from the striking plane and accounts for human self-defense mechanisms to ensure the striking component 20 is directed squarely at the nail 30, addressing both physiological and psychological factors.

Referring to FIG. 13, in another embodiment, the first inclination angle Ais 5 degrees, and the second inclination angle B is 13 degrees.

Referring to FIG. 14, in another embodiment, the first inclination angle A is 8 degrees (upward), and the second inclination angle B is 15 degrees (downward).

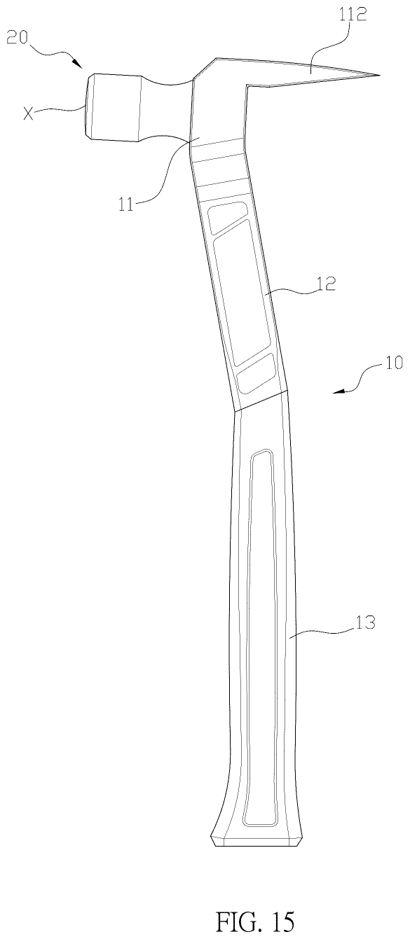

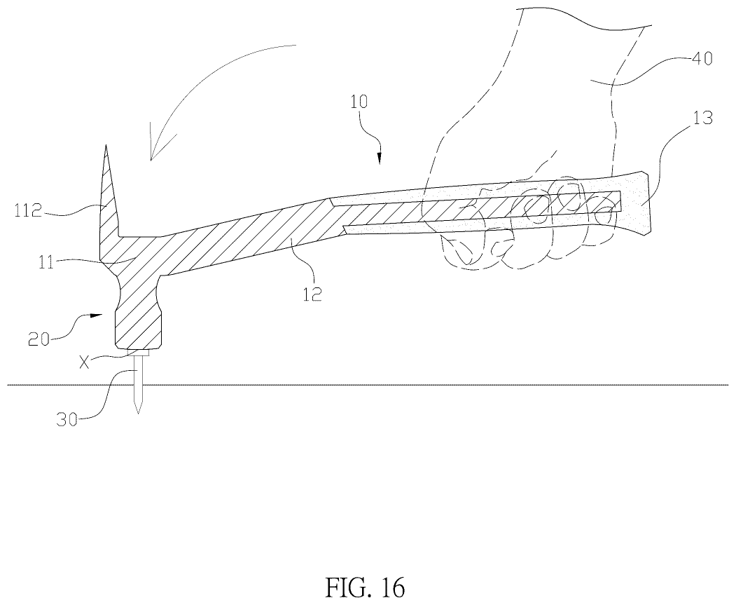

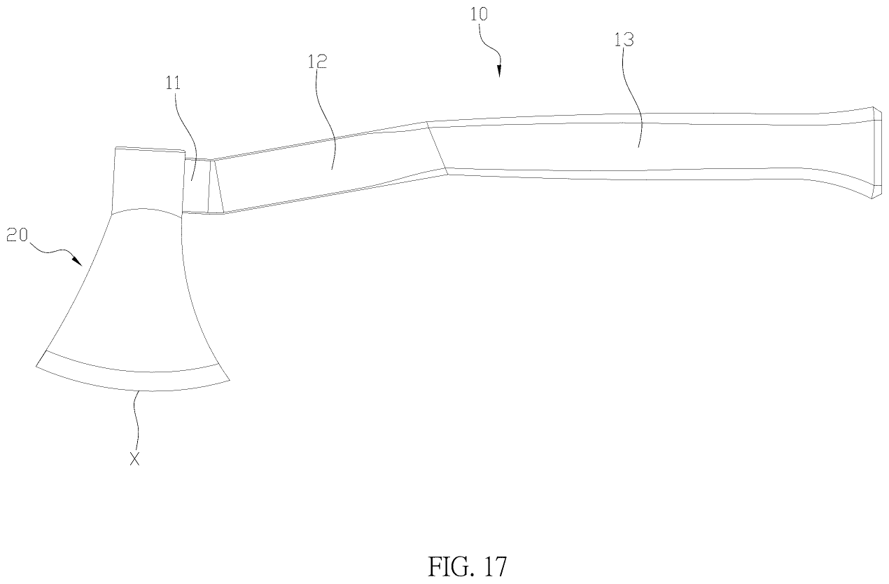

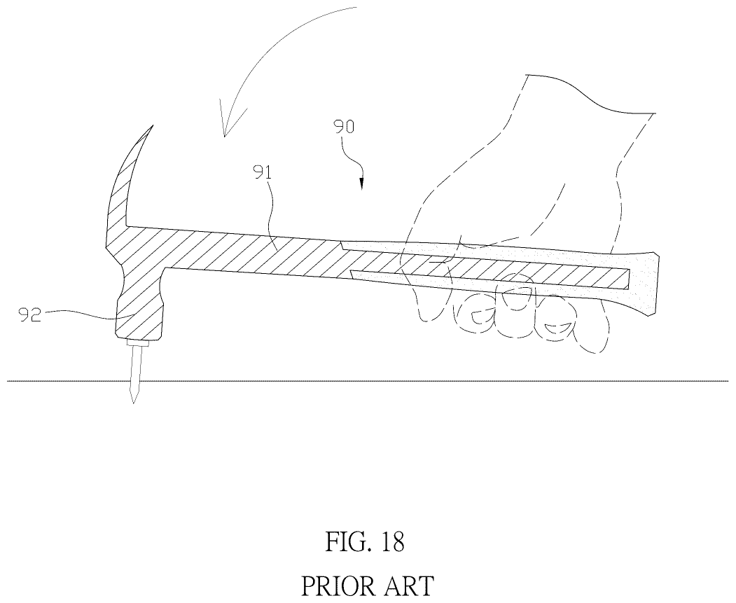

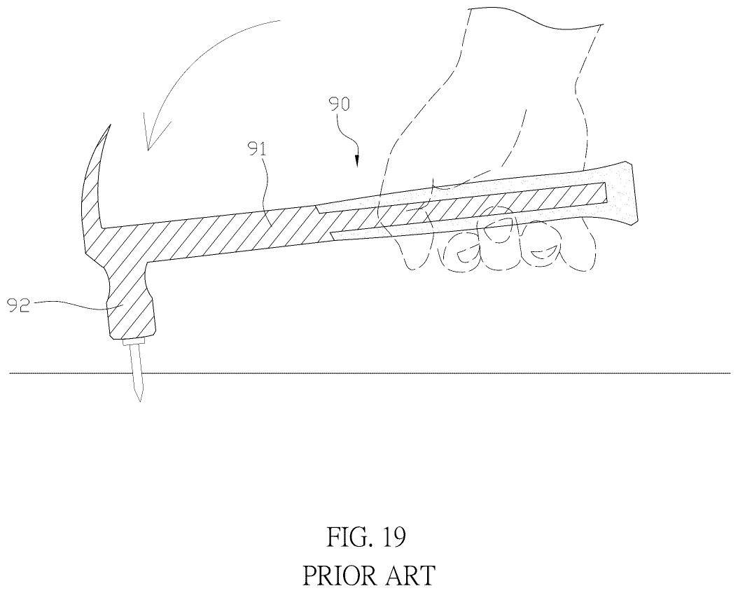

Referring to FIGS. 15-17, in another aspect of the present disclosure, the striking component 20 is integrally formed with the first body 11.

In view of the foregoing, the ergonomic hammer/axe structure of the present disclosure provides the following advantages: since the central axes between the first body 11 and the second body 12, as well as the central axes between the second body 12 and the third body 13, are mutually inclined to define the first inclination angle A and the second inclination angle B, the angle between the third body 13 and the striking component 20 is corrected via the correction of the first inclination angle A and the second inclination angle B. This corrects the striking direction to prevent axial deviation of the nail 30 and prevents excessive tilting of the third body 13, which would otherwise overextend the palm and thenar web space or cause excessive wrist flexion, thereby enhancing grip comfort and preventing work-related injuries.

The specific advantages of the combinations of the first inclination angle A and the second inclination angle B are further detailed below.

According to research conducted in accordance with the present disclosure, high-speed photographic analysis reveals that specific combinations—angle A at 5°/angle B at 10°; angle A at 5°/angle B at 13°; or angle A at 8°/angle B at 15°—ensure the striking head 211 is aligned squarely with the nail 30 during impact. These combinations maintain a neutral wrist alignment where the wrist joint angle remains substantially constant, exhibiting negligible radial deviation, ulnar deviation, palmar flexion, or dorsiflexion. Minor angular variations in the third body 13 are compensated for by the elbow joint and shoulder joint. During impact, the palm fully engages the third body 13 with almost no oscillation, reducing pressure on the palm and mitigating vibration-induced injury which might be otherwise caused to the palm. Consequently, required grip strength is minimized, reducing user fatigue and reducing the risk of occupational injuries associated with prolonged use. All other angular combinations fail to provide these ergonomic advantages. By contrast, straight-handle hammers exhibit significant ulnar deviation during impact as well as substantial palmar and handle oscillation during prolonged use, requiring higher grip force, increasing palmar oscillation, increasing the risk of injuries of the wrist joint and the palm, and causing tendon and joint inflammation, such as trigger finger (stenosing tenosynovitis), tendinitis, carpal tunnel syndrome, white finger syndrome, De Quervain's tenosynovitis, and triangular fibrocartilage complex (TFCC) injuries.

High-speed photography further reveals that at the peak of the upswing of the hammer, the 5°/10° combination exhibits the greatest radial deviation of the wrist joint, where two extensor carpi muscles of the forearm, namely extensor carpi radialis and extensor carpi ulnaris, primarily facilitate the outward extension of the wrist to swing the hammer. The 5°/13° combination exhibits moderate radial deviation of the wrist joint, whereas the 8°/15° combination exhibits the least radial deviation of the wrist joint. During the downstroke, the 5°/10° combination exhibits the greatest range of wrist motion; the 5°/13° combination exhibits a moderate range of wrist motion; and the 8°/15° combination exhibits the least range of wrist motion, with the required force primarily generated by the triceps brachii of the upper arm. The 5°/10° combination is suitable for general DIY use or lightweight hammer designs. The 8°/15° combination is suited for professional users and heavy-duty striking applications. The 5°/13° combination serves as a versatile, general-purpose configuration. All three combinations maintain excellent ergonomics and hammer head perpendicularity. While radial deviation varies during the upswing, the wrist joint is not subjected to impact forces because the hammer is not in a striking phase at this point in the stroke; thus, the substantial intrinsic radial deviation tolerance of the wrist joint precludes tendon injuries and wrist joint injuries despite the radial deviation at the abovementioned three levels.

The design of the first inclination angle A and the second inclination angle B of the handle 10 in the specified combinations (5°/10°, 5°/13°, and) 8°/15° provides ergonomic advantages during prolonged use and mitigates the risk of tendonitis and arthritis caused by prolonged use. These configurations ensure the hammer head remains square to the nail 30 and thereby prevent axial deviation of the nail 30 during impact. The resulting perpendicularity allows for single-handed nail setting without the need to manually stabilize the nail 30, reducing the risk of striking the hand. A parabolic striking face on the hammer head facilitates accurate driving of the nail 30 and minimizes the occurrence of nail misalignment and bending. By maintaining a neutral wrist alignment and facilitating a secure grip and efficient force application, this configuration precludes off-axis tilting of the third body 13 notwithstanding a misaligned strike, enabling the user to maintain a neutral posture and grip the handle 10 with the palmar thenar region, protect vulnerable areas of the hand, preclude vascular compression, and mitigate cumulative trauma to muscles and tendons resulting from prolonged use.

The disclosure is disclosed above by preferred embodiments. However, persons skilled in the art should understand that the embodiments are illustrative of the disclosure only, but shall not be interpreted as restrictive of the scope of the disclosure. Please note that all equivalent variations and modifications made to the embodiments in accordance with scope of the implementation of the disclosure shall be deemed to fall within the scope of the claims of the disclosure.

What is claimed is:

1. An ergonomic hammer/axe structure, comprising:
a handle comprising a first body, a second body, and a third body sequentially connected from a distal end to a proximal end, wherein a central axis of the first body is inclined upward relative to a central axis of the second body by a first inclination angle ranging from 3 degrees to 10 degrees, and a central axis of the third body is inclined downward relative to the central axis of the second body by a second inclination angle ranging from 8 degrees to 17 degrees; and
a striking component disposed perpendicularly to the first body, wherein the first and second inclination angles are configured such that, when a user grips the third body and swings the handle downward to cause the striking component to strike a nail, the striking component impacts the nail squarely via angular correction provided by the first body, the second body, and the third body, maintaining a neutral wrist alignment and preventing the user's palm and thenar web space from being overextended by the third body due to inclination of the handle, wherein the striking component comprises a hammer head or an axe blade and defines a striking face having a parabolic profile.

2. The ergonomic hammer/axe structure of claim 1, wherein the first inclination angle is 5 degrees, and the second inclination angle is 10 degrees.

3. The ergonomic hammer/axe structure of claim 1, wherein the first inclination angle is 5 degrees, and the second inclination angle is 13 degrees.

4. The ergonomic hammer/axe structure of claim 1, wherein the first inclination angle is 8 degrees, and the second inclination angle is 15 degrees.

5. The ergonomic hammer/axe structure of any one of claims 1-4, wherein the first body comprises a nail pulling portion extending from a top portion thereof and configured to remove the nail via leverage.

6. The ergonomic hammer/axe structure of any one of claims 1-4, wherein the striking component is integrally formed with the first body.

7. The ergonomic hammer/axe structure of any one of claims 1-4, wherein the striking component comprises a striking component body, a shock-attenuating spring, and a nut, wherein the first body comprises an assembly hole penetrating therethrough, wherein an end of the striking component body comprises a striking head protruding therefrom, wherein another end of the striking component body extends through the assembly hole and is secured by the nut, wherein the shock-attenuating spring is interposed between the striking head and the first body to elastically absorb vibration, thereby mounting the striking component to the first body.

8. The ergonomic hammer/axe structure of claim 7, wherein the striking component comprises a hammer head, with a rounded fillet disposed at an interface between the striking head and the striking component body, and with a rounded fillet disposed on an inner structure of the shock-attenuating spring and configured to mate with the rounded fillet disposed at the interface between the striking head and the striking component body.

9. The ergonomic hammer/axe structure of claim 7, wherein the striking component comprises an axe blade, with a rounded fillet disposed at an interface between the striking head and the striking component body, and with a rounded fillet disposed on an inner structure of the shock-attenuating spring and configured to mate with the rounded fillet disposed at the interface between the striking head and the striking component body.
